(19) United States
(12) Patent Application Publication
(10) Pub. No.: US 2013/0167799 A1
(43) Pub. Date: Jul. 4, 2013

(54) PROCESS FOR MANUFACTURING A FORMED METALLIC WORK PIECE WITH ARMORING

(71) Applicant: GESENKSCHMIEDE SCHNEIDER GMBH, Aalen (DE)

(72) Inventors: Peter Kolbe, Aalen (DE); Ernst-Peter Schmitz, Abtsgmund (DE); Thomas Körner, Schwelm (DE)

(73) Assignee: GESENKSCHMIEDE SCHNEIDER GMBH, Aalen (DE)

(21) Appl. No.: 13/712,247

(22) Filed: Dec. 12, 2012

(30) Foreign Application Priority Data
Dec. 15, 2011 (DE) 10 2011 056 480.2

(51) Int. Cl. F02F 3/00; B32B 15/01; B23P 15/10

(52) U.S. Cl. CPC F02F 3/003; B23P 15/10; B32B 15/01
USPC 123/193.6; 29/428; 428/594

(57) ABSTRACT

A process for near-net-shape manufacturing of a formed metallic work piece with armoring, with the armoring having different properties than the basic work piece material, including the steps of providing an armoring blank; providing a basic work piece blank; arranging the armoring blank on the basic work piece blank; welding together a surface section of the work piece blank and the armoring blank, thereby creating a blank with an armored surface section; and forming the resulting blank with an armored surface section, thus producing a near-net-shape work piece contour by means of a process which is selected from the group comprising: forging, upsetting, electro upsetting, and extrusion, at a temperature in one of a cold, half-warm and warm temperature range, thereby producing a near-net-shaped formed armored work piece.

### BACKGROUND OF THE INVENTION

1. Field of the Invention

The invention relates to a process for manufacturing a formed metallic work piece with armoring from welded-together metal blanks, and in particular from wrought metal alloys, with the armoring having different properties than the basic work piece material. The invention also relates to work pieces manufactured using this process, such as, e.g., armored pistons. In this way, a material with enhanced resistance to environmental conditions may be permanently applied to a basic material as a protective coating or armor, at least in part.

2. Description of Related Art

The present invention particularly relates to steel pistons. However, it is also suited for gear wheels, pulleys/discs, impellers, poppet valves, bevel gears, crown gears, pistons, valve parts, pump plungers and piston pump parts.

Especially in automotive engineering, increased importance is being attached to components having a long service life and lightweight construction, so that fuel consumption can be minimized, thus reducing CO₂ emissions to below the increasingly strict limits. Although steel work pieces meet the high stability requirements, they are not always scale-resisting. Light metals, especially aluminum alloys, fulfill the necessary weight criteria to a high degree. They are, however, less robust and do react relatively easily with the components of diesel fuels. Other areas of application may include parts in which load mainly occurs in their peripheral areas. Typical examples comprise highly-loaded transport pulleys/discs with roll axes, gear wheels, valve discs, impellers, crown gears, bevel gears, etc., which only in their external areas are subjected to a higher degree of load than in their center, which may be due to the medium in which they operate (e.g., for mixer or conveyor blades) or to mechanical load as, e.g., with sprockets.

### SUMMARY OF THE INVENTION

Therefore, it is an object of the present invention to avoid the drawbacks of the prior art and to develop a process of manufacturing armored work pieces from metal alloys, thus guaranteeing excellent mechanical properties while at the same time being more energy efficient and eco-friendly, and consequently, more cost-effective, than known technologies. Another object of the invention is to develop a work piece which shows the mechanical properties necessary for meeting the extreme load requirements in the armored area.

According to the invention, these objects are achieved by way of a process and a work piece manufactured according to this process as described herein.

According to the invention, the process for manufacturing formed metallic work pieces, such as forged parts with welded-on and forged armoring that exhibits different properties than the basic work piece metal part, comprises: providing an armoring blank; providing a basic work piece blank; arranging the armoring blank on the basic work piece blank; welding together a surface section of the work piece blank and the armoring blank, thereby creating a blank with an armored surface section; and forming the resulting armored blank, thus producing an exterior part contour in its final form by means of a process which is selected from the group comprising: forging, upsetting, electro upsetting, extrusion, with all of the aforesaid processes being performed in the cold or half-warm or warm temperature range, thereby producing a near-net-shape formed armored basic work piece.

It may be necessary for the armoring to comprise a metal which is able to withstand higher mechanical loads than the basic work piece blank. This particularly applies to surfaces that are exposed to high mechanical loads, such as valves, gear wheels, and the like.

However, it may also be desirable for the armoring to comprise a metal that is chemically more resistant than the basic work piece blank, e.g., in the interior lining of the pistons of an internal combustion engine, where the compounds created during combustion may lead to steel corrosion, for example.

The welding process for applying the armoring is preferably selected from the group comprising friction welding, induction welding, WIG, MAG, electron beam or laser welding processes.

Typical armored work pieces that can be manufactured according to the process of the invention comprise, for example, gear wheels, pulleys/discs, impellers, poppet valves, bevel gears, crown gears, pistons, and valve parts or pump plungers. Typically, the armored basic work piece is an armored steel piston for a combustion engine, which is meant to avoid scaling of the material. For this purpose, the armoring may, e.g., be selected from stellite, highly loadable or high-alloyed steel. Another application would be as a piston pump part.

Conjoined forming of basic work piece and armoring can be performed by way of forging, upsetting or extrusion in the cold, half-warm or warm state.

By the process according to the invention, work pieces can be made from alloys which have the mechanical properties of a classic forged part, such as a piston, a valve or a cam, while exhibiting the (chemical) surface properties of other materials. The process according to the invention thus comprises the smallest possible number of process steps, including heating processes, to obtain material substantially from a basic metal alloy, which has high mechanical characteristic values, but also exhibits e.g. the necessary resistance to fuel combustion gases in modern piston combustion chambers, which are subject to high loads. In this way, considerable savings in energy, process and material costs, as well as a prolonged service life, can be obtained, thus not only achieving cost advantages, but also significantly lowering environmental pollution.

According to one embodiment, prior to the forging or forming process the work piece can be heated up to a specific temperature in the range of 450-580° C. Intermediate heating makes it possible to stay within a temperature window of +/−5° C., so that higher process reliability can be warranted.

When using the invention with aluminum parts, the aluminum alloy is a wrought aluminum alloy, particularly an AlMgSi or AlMgSiCu alloy. By using this wrought alloy, according to the process of the invention, work pieces with particularly good mechanical properties, in particular high strength and elongation, can be obtained. Further, it is advantageous to perform the demoulding process at forming temperature. Thereby, no additional intermediate heating will be necessary. The work piece according to the invention may thus consist of substantially one AlMgSi or AlMgSiCu alloy, which is to be provided with an armoring by applying the described process according to the invention. However, wrought titanium alloys and similar light metal alloys may also be used, so that the work piece is especially well suited for highly loaded light constructional and motor vehicle components, while allowing for considerable cost and weight reduction compared to conventional forged parts. Process of connecting metal parts by way of friction welding is well known. In particular it is known, e.g., from German Patent Application DE 32 05 183 A1, how to apply a high temperature material to the complete surface of the highly loaded valve tray of a poppet valve by means of friction welding.

The quality of a formed metal part can be enhanced in order to meet special requirements, with the manufactured part also being very economical with regard to material costs. Here, if the materials of basic work piece and armoring differ with regard to the alloy, the armoring metal part can comprise a hard or high-strength alloy, such as high-temperature steel (for a definition of high-strength alloy see “Stahlschlüssel” 2007, Verlag Stahlschlüssel Wegst 2007), a titanium alloy, an aluminum alloy, a stainless steel alloy or other metal, while for the basic work piece an inferior/softer/chemically less resistant or less expensive metal can be used, which e.g. may also have self-lubricating properties. It is to be understood that work piece alloys do not only comprise steel or aluminum alloys, but also titanium or magnesium alloys, calcium alloys and combinations thereof It is to be understood that the features mentioned above and still to be explained hereafter are not restricted to use in the mentioned combinations, respectively, but may also be used in different combinations of initial components.

The invention will be described in more detail below by using the example of a piston for a combustion engine with an armored interior and by referring to the accompanying drawings, but with the invention in no way being limited to this example.

### BRIEF DESCRIPTION OF THE DRAWINGS

FIG. 1 depicts the start of the welding process with the two initial components that are to be connected and the aligning thereof prior to the connection process; and a welded blank resulting therefrom with an armored surface section, and

FIG. 2 is a cross-sectional view of a near-net-shape armored work piece that has been formed into a piston part with a single forging stroke.

### DETAILED DESCRIPTION OF THE INVENTION

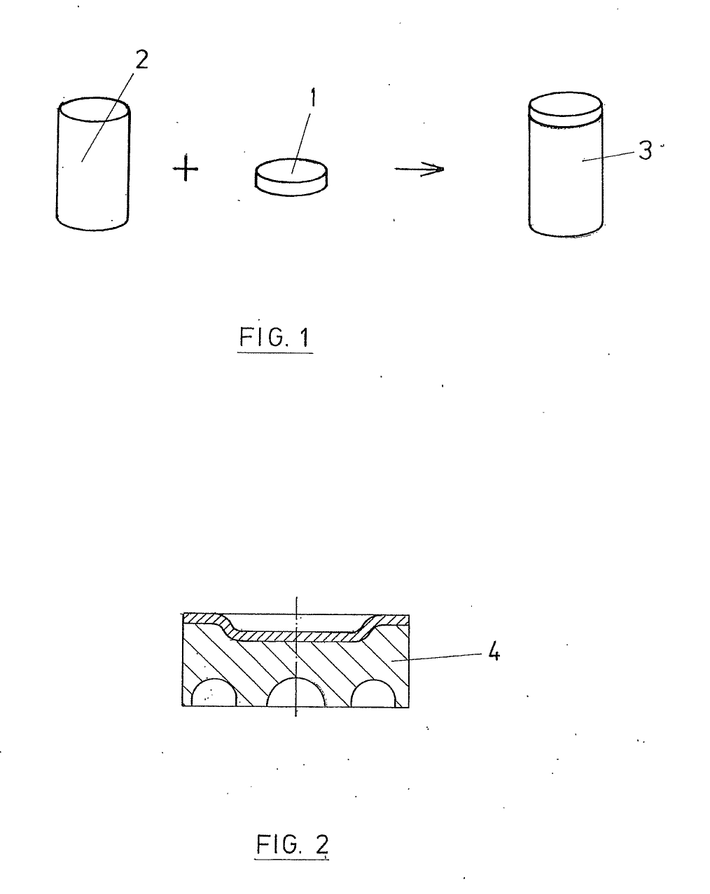

FIGS. 1 & 2 illustrate the production of a near-net-shaped armored forged piston part according to the process of the invention. FIG. 1 shows the two initial parts, i.e., the armoring blank 1, which is a steel billet in this case, and the basic work piece blank 2 which, here, has the same outer diameter as the basic work piece blank 2. Both blanks 1, 2 are arranged in relation to each other, with the longitudinal axes of the blanks being aligned, and welded together forming a weld surface. Now, the metal assembly 3 welded in this manner is formed by forging into a welded near-net-shaped, semi-finished, product 4 which comprises the material part and the armoring, thus obtaining a final form-fitting connection between both blanks in the formed armored forged near-net-shaped part 4.

Preferably, the near-net-shape work piece contour is produced by means of a process which is selected from the group comprising: forging, upsetting, electro-upsetting, and extrusion, the process being performed at one of a cold, half-warm or warm temperature range. In this regard, a half-warm temperature in relation to steel is a temperature in the range of between about 700° C. to about 950° C. and is one where essentially no cinder/scale is formed on the metal, whereas cinder/scale is formed at a warm temperature which is a temperature in the range of between about 900° C. to about 1250° C., the particular temperature in each case being dependent on the specific material used.

Thereby, a safe and secure connection between armoring and basic work piece is created. A typical billet for the piston part is formed of an iron alloy. A suitable material may be a forging tool steel, such as the hot-working steels 1.2367, 1.2714, 1.2344, while a typical armoring material would be a high-alloyed steel, such as Nimonic or another stainless steel alloy, which may be an X steel, but also stellite or another alloy that can be welded to the basic work piece, as well as other obvious materials known to a person skilled in the art.

While the invention has been described by way of preferred embodiments, other alternative designs and embodiments for practicing the invention will be evident to persons skilled in the art for which the invention is intended.

What is claimed is:

1. Process for near-net-shape manufacturing of a formed metallic work piece with armoring, with the armoring having different properties than the basic work piece material, including the steps of:
providing an armoring blank;
providing a basic work piece blank;
arranging the armoring blank on the basic work piece blank;
welding together a surface section of the work piece blank and the armoring blank, thereby creating a blank with an armored surface section; and
forming the resulting blank with an armored surface section, thus producing a near-net-shape work piece contour by means of a process which is selected from the group comprising: forging, upsetting, electro upsetting, and extrusion, at a temperature in one of a cold, half-warm and warm temperature range, thereby producing a near-net-shaped formed armored work piece.

2. Process according to claim 1, wherein the armoring blank comprises a metal which can withstand a higher mechanical load than the basic work piece blank.

3. Process according to claim 1, wherein the armoring blank is formed of a metal that is more chemically resistant than the basic work piece blank.

4. Process according to claim 1, wherein the welding process is selected from the group comprising friction welding, induction welding, WIG, MAG, electron beam and laser welding.

5. Near-net-shaped armored metal work piece produced according to the process of of the claim 1, wherein work piece has a near-net shape selected from the group comprising gear wheels, castors, impellers, poppet valves, bevel gears, crown gears, pistons, valve parts, pump plungers.

6. Near-net-shaped armored metal work piece according to claim 5, wherein the near-net shape is that for an armored steel piston for a combustion engine.

7. Near-net-shaped armored metal work piece according to claim 5, wherein the near-net shape is that for an armored part for a piston pump.

8. Near-net-shaped armored metal work piece according to claim 5, wherein the near-net shape work piece has an armoring of a material selected from the group comprising stellite, highly loadable and high-alloyed steel.

9. Process according to claim 1, wherein the forming is performed at a warm temperature in a range of about 900° C. to about 1250° C.

10. Process according to claim 1, the forming is performed at a half-warm temperature in a range of about 700° C. to about 950° C.
